(19) United States
(12) Patent Application Publication
(10) Pub. No.: US 2026/0117840 A1
(43) Pub. Date: Apr. 30, 2026

(54) ENERGY ABSORBING DEVICE

(71) Applicant: Havenseats Ltd, Hevel Modiin Region Industrial Park (IL)

(72) Inventors: Anan HASAN, Julis (IL); Shy MINDEL, Hod-HaSharon (IL); Oren GOOR, Savyon (IL); Yury ANTONOV, Netanya (IL)

(73) Assignee: Havenseats Ltd, Hevel Modiin Region Industrial Park (IL)

(21) Appl. No.: 19/145,579

(22) PCT Filed: Jan. 3, 2024
(86) PCT No.: PCT/IL2024/050012

§ 371 Date: Jul. 3, 2025

Related U.S. Application Data
(60) Provisional application No. 63/436,922, filed on Jan. 4, 2023.

(51) Int. Cl. F16F 13/00

(52) U.S. Cl. CPC F16F 13/00; F16F 2224/0208; F16F 2232/08; F16F 2234/02

(57) ABSTRACT

An energy absorbing device including multiple cylindrical base members and multiple metallic helical bands coaxially located around a common longitudinal axis congruent to each other. The multiple helical bands having a bottom end connected to a bottom base member and a top end connected to a top base.

### RELATED APPLICATION/S

This application claims the benefit of priority of U.S. Provisional Patent Application No. 63/436,922 filed on Jan. 4, 2023, the contents of which are incorporated herein by reference in their entirety.

### FIELD AND BACKGROUND

The present disclosure, in some embodiments thereof, relates to an energy-absorbing device and, more particularly, but not exclusively, to an energy-absorbing device and a method for usage thereof to protect people and/or objects, for example, as utilized in armored vehicles and/or the like.

### SUMMARY

It is an object of the present disclosure to provide an energy-absorbing device and, more particularly, but not exclusively, to an energy-absorbing device and a method for usage thereof to protect people and/or objects, for example, as utilized in armored vehicles and/or the like.

According to an aspect of some embodiments of the present invention there is provided an energy absorbing device including multiple cylindrical base members and multiple metallic helical bands coaxially located around a common longitudinal axis congruent to each other. The multiple helical bands having a bottom end connected to a bottom base member and a top end connected to a top base.

Optionally, the multiple cylindrical helical members may be formed in a single hollow cylindrical body by multiple coaxial helical cuts through the single hollow cylindrical body relative to the longitudinal axis.

More optionally, multiple connecting members may be located and attached between the multiple cylindrical helical members along the longitudinal axis.

Optionally, multiple uncut sections in the single hollow cylindrical body relative to the longitudinal axis may form each of the connecting members of the multiple connecting members.

Optionally, pairs of the multiple connecting members may be located laterally opposite each other and aligned with each other along the longitudinal axis.

Optionally, the multiple cylindrical base members may be substantially aligned opposite to each other with respect to the longitudinal axis to form at least one of a right hollow cylinder, oblique hollow cylinder and elliptic hollow cylinder.

Optionally, application of an axial force across the multiple cylindrical base members, may simultaneously apply a shear force to each connecting member of the multiple connecting members.

More optionally, a predesigned value of the shear force may break the multiple connecting members, to open and to elongate and deform substantially inwardly the multiple cylindrical helical members.

Optionally, a first predesigned value of the shear force breaks a first portion of the plurality of connecting members and a second predesigned value of the shear force breaks a second portion of the plurality of connecting members different than the first portion.

Optionally, an increasing series of predesigned values of the shear force break different and disjoint portions of the plurality of connecting members at a predefined order thereamong.

Optionally, the plurality of connecting members having a variable cross sectional area thereby the increasing series of predesigned values of the shear force break the plurality of connecting members at the predefined order according to respective cross sectional areas thereof.

Optionally, the plurality of cylindrical helical members comprising a first and second different and disjoint portions of consecutive cylindrical helical members, each associated with a different one of a first and second set of predesigned values of the shear force as a function of travel of respective consecutive cylindrical helical members therein, the predesigned values in the first and second set respectively are greater than one another per each travel unit.

Optionally, the predesigned values in the first and second set are greater than one another by a magnitude substantially proportional to a ratio between a pitch of respective cylindrical helical members in each of the first and second portions.

Optionally, the multiple cylindrical base members may be laterally displaced opposite to each other with respect to the longitudinal axis to form an oblique cylinder, triangular, square, rectangular, hexagonal, or any polynomial shape in cross section.

According to another aspect of some embodiments of the present invention there is provided an object located and attached in at least one of a vehicle, a vehicular seat, an elevator and a shelf. The object may include one or more of the features of at least one energy absorbing device in accordance with the disclosed subject matter herein.

According to one technical effect of utilizing the disclosed subject matter, there is provided an energy absorbing device and method for energy absorption by use thereof, such as in armored vehicles and/or the like. The energy absorption may be, for example, from an impact of a missile, to mitigate damage and/or injury to a person and/or an object inside an armored patrol car (APC). The object may be a seat or a sensitive piece of equipment attached to the APC and/or stored in a cabinet or on a shelf of the APC.

According to another technical effect of utilizing the disclosed subject matter, an energy absorption of an energy absorbing device and/or method for usage thereof may be, e.g., for a road vehicle from a side impact of another road vehicle, to mitigate damage or injury to a person and/or an object inside the road vehicle.

The foregoing and other objects are achieved by the features of the independent claims. Further implementation forms are apparent from the dependent claims, the description and the figures.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1A shows a schematic side view of and a schematic cross-sectional view of an energy absorbing device in its undeformed state, in accordance with some embodiments;

FIG. 1B, shows a schematic panoramic view and a schematic top view of an energy absorbing device in its plastically deformed state, in accordance with some embodiments.

FIG. 2A shows a schematic side view of and a schematic cross-sectional view of an energy absorbing device in its undeformed state, in accordance with some embodiments;

FIG. 2B shows a schematic panoramic view and a schematic top view of an energy absorbing device in its plastically deformed state, in accordance with some embodiments;

FIG. 3A shows a side view of an energy-absorbing device and a detailed view of a connecting member in their undeformed state, in accordance with some embodiments;

FIG. 3B shows a perspective side view of an energy absorbing device and a detailed view of a connecting member in their undeformed state, in accordance with some embodiments;

FIG. 3C shows two cross sectional side views indicated in FIG. 3B, as a line of cross section of an energy absorbing device in its undeformed state, in accordance with some embodiments;

FIG. 4 shows a test-measuring arrangement for energy absorbing device, in accordance with some embodiments;

FIG. 5 shows a utilization scenario that demonstrates a need for the use of an energy absorbing device, in accordance with some embodiments;

FIG. 6 shows another utilization scenario for the use of an energy absorbing device, in accordance with some embodiments;

FIG. 7 shows a schematic side view and a schematic cross-sectional view of exemplary energy absorbing devices with connecting members of equal and variable size respectively, in accordance with some embodiments;

FIG. 8A shows a schematic side view of an exemplary energy absorbing device with variable strength sections, in accordance with some embodiments; and

FIG. 8B shows a schematic graph representing an axial force magnitude as a function of an elongation travel of either one of and/or both variable strength sections of the energy absorbing device as shown on FIG. 8A, in accordance with some embodiments.

### DETAILED DESCRIPTION

The present disclosure, in some embodiments thereof, relates to an energy-absorbing device and, more particularly, but not exclusively, to an energy-absorbing device and a method for usage thereof to protect people and/or objects, for example, as utilized in armored vehicles and/or the like.

By way of introduction aspects of the disclosure below, the disclosure describes a device to absorb energy from an impact. The device may be disposed between a sidewall of a vehicle and an object, where the impact hits with an axial force lateral to the object. The impact may come from a missile or another object/vehicle. The object may include a seat for a passenger or a shelf attached to the vehicle so that the device may absorb the energy of the impact in order to mitigate damage or injury to the object and/or the passenger respectively.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments and/or of being practiced and/or carried out in various ways.

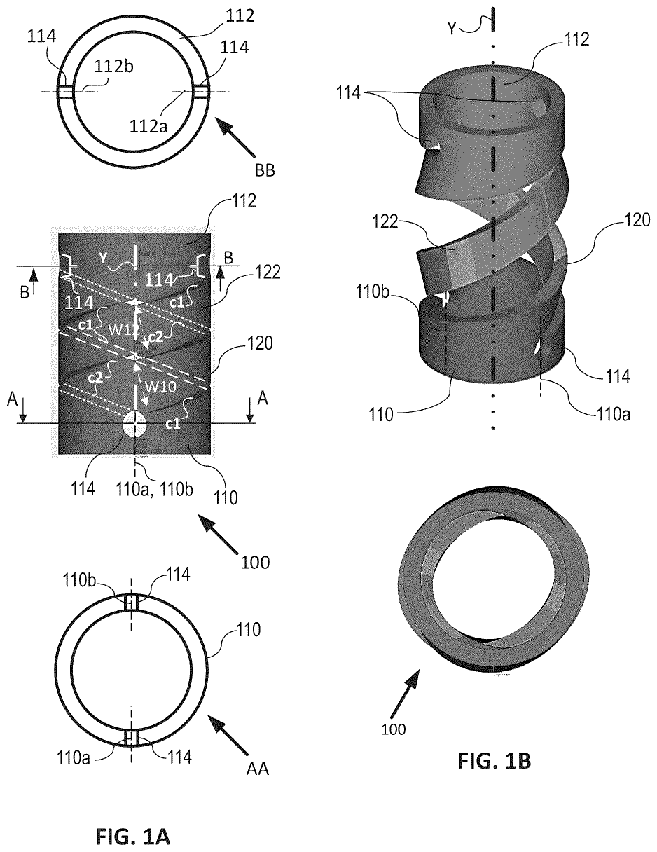

Reference is now made to FIG. 1A, which shows a schematic side view and a schematic cross-sectional view AA of energy absorbing device 100 in its undeformed state, in accordance with some embodiments. Energy absorbing device 100 is shown implemented as a right cylinder, meaning that base members 110 and 112 are circular. However, such depiction as shown and illustrated on FIG. 1A herein is not meant to be limiting, and the energy absorbing device 100 may be implemented as a right cylinder, oblique cylinder or an elliptic cylinder, for example. Further, for example, base members 110 and 112 may be triangular, square, rectangular, hexagonal or any polynomial shape in cross section. Energy absorbing device 100 is shown implemented as a double helix formed by two helical members 120 and 122 with respective widths W10 and W12. Each of the helical members 120 and 122 radially extend along a longitudinal axis Y between base members 110 and 112. With reference to the schematic cross-sectional view BB at base 112, two top holes 114 are laterally opposite each other. With reference to the schematic cross-sectional view AA at base 110, two bottom holes 114 are laterally opposite each other. Comparing cross-sectional view AA and cross-sectional view BB, first and second locations 110a, 110b are radially offset from first and second locations 112a, 112b by an angle of ninety degrees respectively.

Each hole 114 begins respective spiral cuts c1 and c2 where helical members 120 and 122 attach to base member 110. Spiral cut c1 terminates at the top right hand top hole 114 (indicated by a right hand brace) and spiral cut c2 terminates at the left hand top hole 114 (indicated by a left hand brace) where helical members 120 and 122 attach to base member 112. Wider dashed lines and narrow dashed lines show spiral cut c1 and spiral cut c2 respectively going around the back of energy absorbing device 100. Therefore, spiral cut c1 and spiral cut c2 are congruent to each other and with rhombus shaped points of superposition along the longitudinal axis Y. Holes 114 are utilized to distribute stress and strain when axial force is applied across base members 110 and 112. Both helical members 120 and 122 connect to base members 110 and 112.

Helical members 120 and 122 and other helical members described below may be formed in a single hollow cylindrical body using a laser cutting, machining or by casting, forming/forging, injection molding or composite forming to form energy absorbing device 100. Examples of composite materials may include concrete, fibre-reinforced polymers, carbon fibre and metal fibres reinforcing other metals as in metal matrix composites (MMC). Energy absorbing device 100 may be formed from a single hollow metallic cylindrical body for example. The single hollow metallic cylindrical body may be made from, or may include spring steel, mild steel, aluminum, a titanium alloy, plastic and composite material such as carbon fiber for example.

Reference is now made to FIG. 1B, which shows a schematic panoramic view and a schematic top view of energy absorbing device 100 in its plastically deformed state, in accordance with some embodiments. Both the schematic panoramic view and the schematic top view of energy absorbing device 100 shows the results of an axial force applied across energy absorbing device 100. The axial force is any force that directly acts on the longitudinal axis Y of absorbing device 100. The axial force may include forces that are a stretching force or a compression force, depending on direction of the force applied to energy absorbing device 100. In terms of the stretching force, where below a certain level of the compression force applied, a deformation of energy absorbing device 100 occurs. Once the stretching force is removed, energy-absorbing device 100 returns to its normal shape. Therefore, energy-absorbing device 100 allows for an elastic deformation so long as the stretching force being applied does not exceed the durability of energy absorbing device 100. If the stretching force becomes too great, the deformation will change from an elastic deformation to a plastic deformation. Plastic strain is caused by rearrangement of the atoms in the material of energy absorbing device 100 and is not reversible. When the stress is removed the plastic deformation remains in energy absorbing device 100.

Application of opposing axial forces on first and base members 110, 112 of energy absorbing device 100 may cause plastic elongation and plastic radial deformation of helical members 120, 122 of energy absorbing device 100. Connection of both helical members 120, 122 to base member 110 of energy absorbing device 100 at opposing first and second locations 110a, 110b, and both helical members 120, 122 to base member 112 respectively, may cause helical members 120, 122 to deform inwardly upon elongation of energy absorbing device 100. The radial deformation of helical members 120, 122 may be symmetric or substantially symmetric, for example as shown in FIG. 1B.

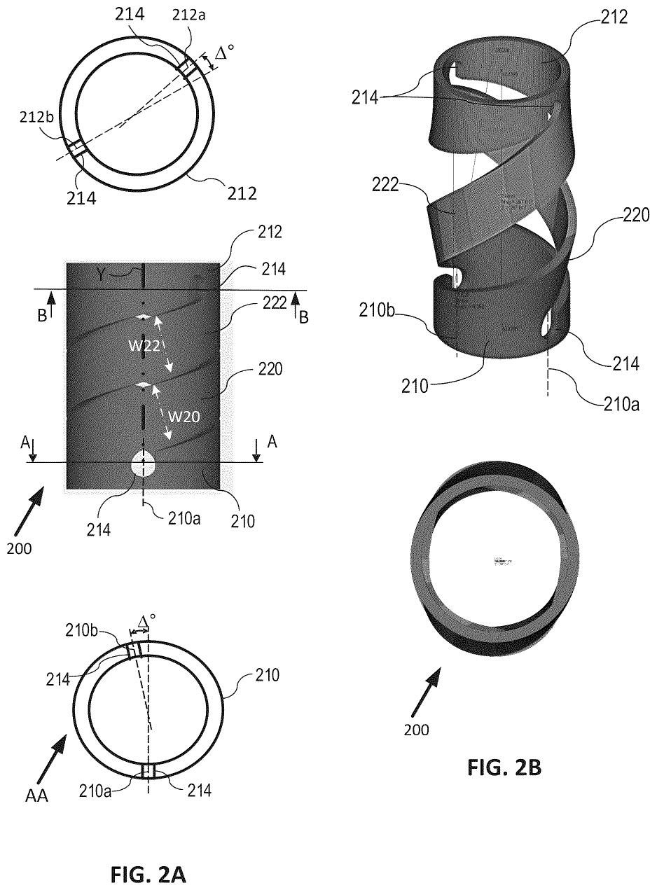

Reference is now made to FIG. 2A, which shows a schematic side view and a schematic cross-sectional view AA of energy absorbing device 200 in its undeformed state, in accordance with some embodiments. Each of the two holes 214 begin respective spiral cuts where helical members 220 and 222 attach to base member 210. One spiral cut terminates at the top right hand top hole 214 and the other spiral cut terminates at the left hand top hole 214 (not shown) where helical members 120 and 122 attach to base member 212. The spiral cuts are congruent to each other and with rhombus shaped points of superposition along the longitudinal axis Y. Holes 214 are utilized to distribute stress and strain when axial force is applied across base members 210 and 212. Both helical members 220 and 222 connect to base members 210 and 212.

Helical member 220 may be connected at its first end to base member 210 at a first location 210a and helical member 222 may be connected at its first end to base member 210 at a second location 210b along a circumference of base member 210. Similarly, helical member 220 may be connected at its second end to base member 212 at a first location 212a and helical member 222 may be connected at its first end to base member 212 at a second location 212b along a circumference of base member 210. In some embodiments, first location 210a and second location 210b may be non-opposite to each other as shown in cross section AA. For example, second location 210b may be at an angle of 180°+Δ° from first location 210a along the circumference of base member 210 as shown in cross section AA. In some embodiments, Δ° may range between 0° to 90° degrees, 0 to 180° degrees, and 0° to 120° degrees.

Similarly, first location 212a and second location 212b may be non-opposite to each other as shown in cross section BB. For example, second location 212b may be at an angle of 180°+Δ° from first location 212a along the circumference of base member 210 as shown in cross section BB. In some embodiments, Δ° may range between 0° to 90° degrees, 0 to 180° degrees, and 0° to 120° degrees. The angular offset Δ° when comparing energy absorbing device 100 with energy absorbing device 200 results in the widths W10 and W12 of respective helical members 120 and 122 being narrower than the widths W20 and W22 of respective helical members 220 and 222.

Reference is now made to FIG. 2B, which shows a schematic panoramic view and a schematic top view of energy absorbing device 200 in its plastically deformed state, in accordance with some embodiments. Application of opposing axial forces on base members 210, 212 of energy absorbing device 200 may cause plastic elongation and plastic radial deformation of helical members 220, 222 of energy absorbing device 200. Connection of helical members 220, 222 to base member 210 of energy absorbing device 200 at non-opposing first and second locations 210a, 210b and both helical members 220, 222 to base member 212 at non-opposing first and second locations 220a, 220b respectively. May cause first and helical member 120, 122 to deform outwardly or substantially outwardly upon elongation of energy absorbing device 200. The radial deformation of helical members 220, 222 may be symmetric or substantially symmetric, for example as shown by the schematic panoramic view and the schematic top view of energy absorbing device 200.

By way of non-limiting example, an experiment was conducted with energy absorbing device 200 having an initial length of 200 mm, an initial wall thickness of 8 mm, an initial inner diameter of 108 mm and an initial outer diameter of 124 mm. In the experiment, opposing axial forces have been applied on base members 210, 212 of energy absorbing device 200 to cause plastic elongation of energy absorbing device 200 by 69 mm with respect to its initial length. Experimental results showed that elongated energy absorbing device 200 had a minimal inner diameter of 96 mm (which is a reduction of 11.1% with respect to initial inner diameter of 108 mm) and a maximal outer diameter of 144 mm (which is an increase of 16.1% with respect to initial outer diameter of 124 mm). Experimental results further showed that elongated energy-absorbing device 200 has twisted by 9° with respect to its initial undeformed state. Various other absorbing devices 200 with one parameter changed with all others the same were tested. For example, a change in the inner diameter of absorbing device 200 from 15 millimeters (mm) to 200 mm decreased the deformation profile force. A change in the wall thickness of absorbing device 200 from 2 mm to 20 mm increased the deformation profile force. A change in the number (n) of windings of first and helical members 220 and 222 of n=1.5 to 10 and n=1.5 to 10 respectively, increased the deformation profile elongation.

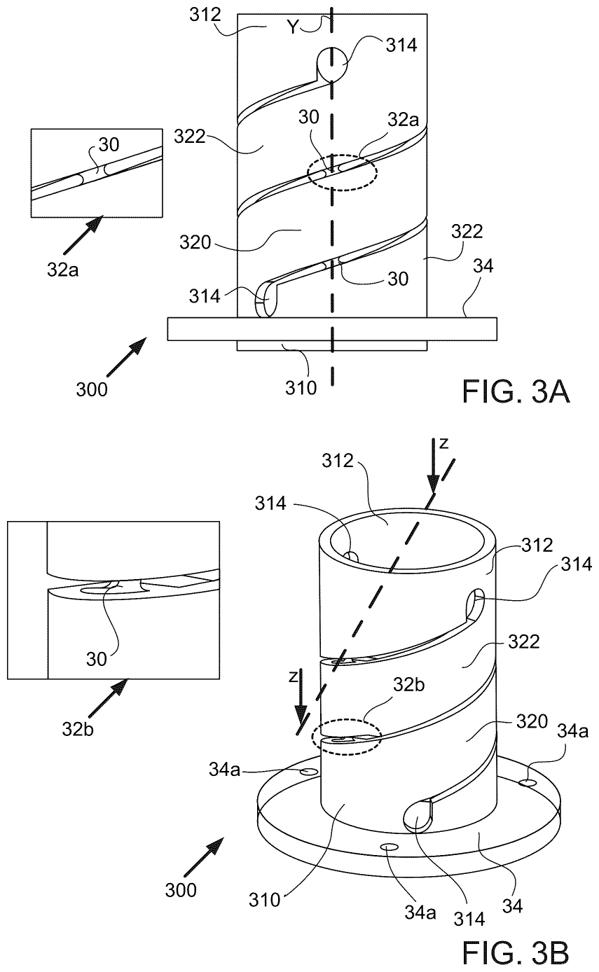

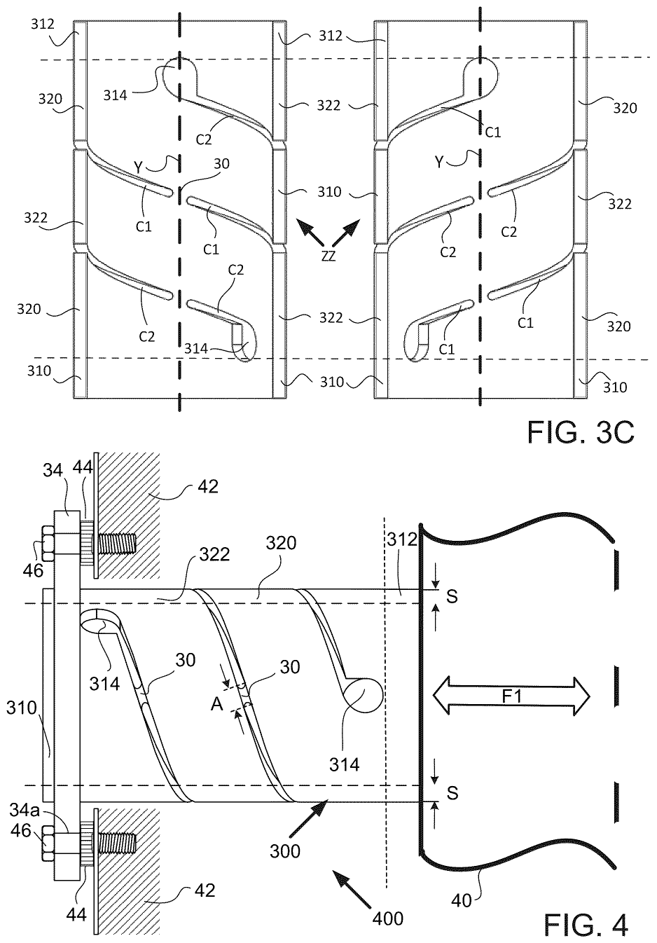

Reference is now made to FIG. 3A that shows a side view of an energy absorbing device 300 and a detailed view of a connecting member 30 in their undeformed state, in accordance with some embodiments. Energy absorbing device 300 is shown with base member 310 mechanically attached to a flange 34. Energy absorbing device 300 is similar to energy absorbing device 200 in that first location 210a and second location 210b of energy absorbing device 200 may be non-opposite to each other as shown in FIG. 2A. Helical member 320 is connected at its first end to base member 310 and helical member 322 is connected at its first end to base member 310 along a circumference of base member 210. Similarly, helical member 320 is connected at its second end to base member 312 and helical member 322 is connected at its first end to base member 312 along a circumference of base member 310.

Each of the two holes 314 (only one hole shows) begin respective spiral cuts where helical members 320 and 322 attach to base member 310. Both spiral cuts terminate with respective top holes 314 laterally opposite each other where helical members 320 and 322 attach to base member 312. The spiral cuts are congruent to each other. Holes 314 are utilized to distribute stress and strain when axial force is applied across base members 310 and 312. Both helical members 320 and 322 connect to base members 310 and 312. Cylindrical helical members 320 and 322 may be formed in a single hollow cylindrical body, by multiple coaxial helical cuts through the single hollow cylindrical body relative to the longitudinal axis Y. Two connecting members 30 are shown located and attached between helical members 320 and 322 along the longitudinal axis Y. A connecting member 30 may be formed in the uncut sections in the single hollow cylindrical body relative to the longitudinal axis Y. Connecting members 30 (not sown) may be located laterally opposite each other perpendicular to the longitudinal axis Y and aligned with each other vertically as shown along the longitudinal axis Y.

Reference is now made to FIG. 3B that shows a perspective side view of an energy absorbing device 300 and a detailed view 32b of a connecting member 30 in their undeformed state, in accordance with some embodiments. A line of cross section Z passes through the single hollow cylindrical body that includes helical members 320 and 322. Helical members 320 and 322 connect to base members 310 and 312. Base member 310 is attached to flange that includes holes 34a. Holes 314 are utilized to distribute stress and strain when axial force is applied across base members 310 and 312. Both helical members 320 and 322 connect to base members 310 and 312.

Reference is now made to FIG. 3C that shows two cross sectional side views ZZ indicated in FIG. 3B as line of cross section Z, of an energy absorbing device 300 in its undeformed state, in accordance with some embodiments. In the left hand cross sectional drawing, spiral cut C2 begins with hole 314 where helical members 320 and 322 attach to base member 310. Spiral cut C2 terminates at the top hole 314 in the middle of longitudinal axis Y and terminates at hole 314 located at the right hand side of the hollow cylindrical body where helical members 320 and 322 attach to base member 310. Similarly, in the right hand cross sectional drawing, spiral cut C1 begins with hole 314 where helical members 320 and 322 attach to base member 310. Spiral cut C1 terminates at the top hole 314 in the middle of longitudinal axis Y and terminates at hole 314 located at the left hand side of the hollow cylindrical body where helical members 320 and 322 attach to base member 310. Holes 314 are utilized to distribute stress and strain when axial force is applied across base members 310 and 312. Both helical members 320 and 322 connect to base members 310 and 312.

Reference is now made to FIG. 4, which shows a test-measuring arrangement 400 for energy absorbing device 300, in accordance with some embodiments. The energy absorbing device 300 is shown attached to a rigid wall 42, rigid wall 42 by way of non-limiting example may be a side wall of an armored vehicle. The hollow cylindrical body of energy absorbing device 300 that includes helical members 320 and 322, holes 314, base members 310, 312 and connecting members 30 passes through a circular hole in rigid wall 42. Energy absorbing device 300 attaches to rigid wall 42 by use of flange 34 and holes 34a. Bolts 46 pass through holes 34a and force sensors 44. Bolts 46 screw into rigid wall 42, thereby attaching the hollow cylindrical body at base member 310 to rigid wall 42. A load 40 attaches to base member 312. Load 40 by way of non-limiting example may be a chair for the armored vehicle or attached to an anti-missile system. The hollow cylindrical body of energy absorbing device 300 has a wall thickness S and length A for each connecting member 30. Table 1 below shows the resultant shear force for combinations various sizes of the wall thickness S and length A for each connecting member 30. In general, for energy absorbing device 300, Young's modulus E=205×10⁺¹² Pascals [Gpa], Poisson ratio: 0.3, Weight: 7.5 kg, Length: 220 mm, outer diameter 124 mm, flange 34 thickness: 15 mm and hollow cylindrical body is steel (St-52/SAE 1024).

TABLE 1

| | | Thickness | |
|---|---|---|---|
| | A | S | Shear force |
| | [mm] | [mm] | [N] |
| 1 | 5 | 8 | 14000 |
| 2 | 3 | 8 | 8400 |
| 3 | 5 | 6 | 10500 |
| 4 | 3 | 6 | 6300 |
| 5 | 2 | 4 | 2800 |
| 6 | 8 | 2 | 5600 |

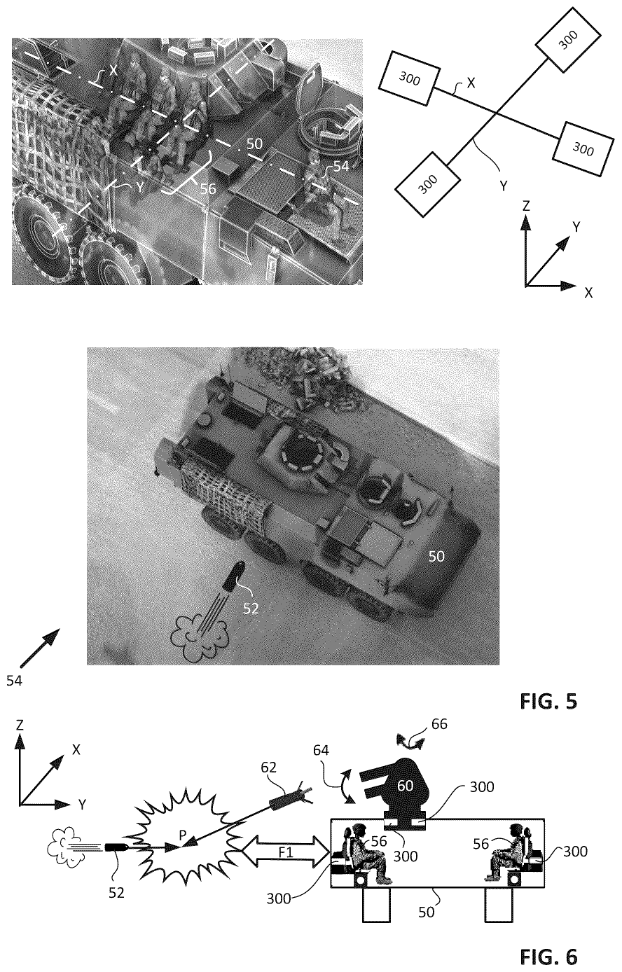

Reference is now made to FIG. 5, which shows a utilization scenario that demonstrates a use of energy absorbing device 300, in accordance with some embodiments. The top drawing shows a partial inside view of an armored personnel carrier (APC) 50. The top two drawings include passengers 56, passengers 56 are seated perpendicular to driver 54 inside armored personnel carrier 50. The bottom drawing shows a projectile 52 fired at one side of APC 50. The use of energy absorbing device 300 in this case would be to protect passengers 56 and driver 54 from the damaging effects of projectile 52 fired at APC 50 and hitting the side of APC 50. Projectile 52 hitting one side of APC 50 means that the backs of passengers 56 at the one side may be protected by the energy absorbing properties of energy absorbing device 300 included in the seats sat on by passengers 56.

Similarly, the fronts of passengers 56 on the opposite side of the one side may be protected by the energy absorbing properties of energy absorbing device 300 included in the seats. Further, the side of driver 54 may be protected by the energy absorbing properties of energy absorbing device 300 included in the driver seat. In the horizontal XY plane with respect to vertical axis Z of APC 50, multiple absorbing devices 300 may be included the seats or other items in APC 50 such as a shelf or a cabinet. Two of the absorbing devices 300 may be opposite each other along the X-axis and another two absorbing devices 300 may be opposite each other along the Y-axis included for example in the seats sat on by both passengers 56 and driver 54. Therefore, both passengers 56 and driver 54 or any other object attached to APC 50 may be protected by the energy absorbing properties of each energy absorbing device 300 from projectiles 52 fired at the front, the rear and the sides of APC 50.

Reference is now made to FIG. 6 that shows another utilization scenario for the use of energy absorbing device 300, in accordance with some embodiments. A cross section of armored personnel carrier (APC) 50 is shown where APC 50 further includes an anti-missile system 60. Anti-missile system 60 includes a radar tracking system (not shown) operatively attached to anti-missile system 60. Passengers 56 are shown seated in seats opposite each other and the seats include one or more each energy absorbing devices 300. As described above, four energy absorbing devices 300 may be located in the XY plane attached to and included in the seats and/or between a turret (not shown) of APC 50. The turret is utilized to enable rotation of anti-missile system 60 about the z-axis, shown by double arrow 66. The launch barrels of anti-missile system 60 are enabled by anti-missile system 60 to move up and down, shown by double arrow 64.

The radar tracking system detects, tracks and provides a response to projectile 52 fired at APC 50. The response is to fire a missile 62 at projectile 52. In the process of firing missile 62 at projectile 52, any recoil of anti-missile system 60 firing missile 62 may be absorbed by multiple energy absorbing devices 300 connected between the turret of APC 50 and anti-missile system 60. Interception between projectile 52 and missile 62 occurs at point P in order to neutralize the potential explosive damage to passengers 56 shown as axial force F1. Since the amount of explosive power of projectile 52 may not be known, the potential damage to passengers 56 may only be partially neutralized by missile 62, or missile 62 has a greater explosive power than projectile 52. Axial force F1 therefore, may be because of missile 62 having a greater explosive power than projectile 52, projectile 52 having a greater explosive force than missile 62 or that missile 62 misses projectile 52 and projectile hits APC 50 directly.

Therefore, multiple absorbing devices 300 included the seats sat on by both passengers 56, driver 54 and any other object attached to APC 50 including anti-missile system 60, may be protected by the energy absorbing properties of each energy absorbing device 300. The energy absorbing protection of multiple energy absorbing devices 300, according to aspects described herein is from projectiles 52 potentially fired at the front, the rear and the sides of APC 50. In an alternative to projectiles 52, projectile 52 may be another vehicle to cause a T-bone accident with APC 50 or another vehicle. A T-bone accident, also known as a side impact or broadside accident occurs when the front of one vehicle crashes into the side of another. This type of accident may generally occur at a road intersection when one of the vehicles fails to stop at a stoplight or stop sign. The occupants sitting on the side of the vehicle, struck broadside may usually suffer the most serious injuries. Therefore, a benefit of the aspects described above, enables energy absorption by use of features of absorbing device 300 described above from an impact, in order to mitigate damage or injury to a person and/or an object respectively. The object may be a seat or a sensitive piece of equipment attached to APC 50 and/or stored in a cabinet or on a shelf.

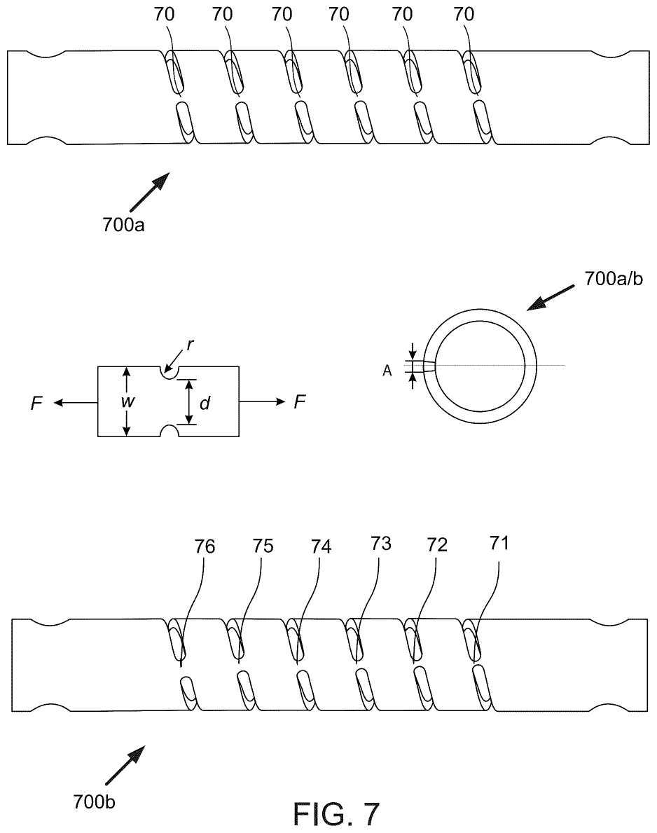

Reference is now made to FIG. 7 that shows a schematic side view and a schematic cross-sectional view of exemplary energy absorbing devices with connecting members of equal and variable size respectively, in accordance with some embodiments.

In some embodiments, connecting member(s) such as 30 of FIGS. 3A-3C and 4 herein, also referred to herein as “fuse(s)” interchangeably throughout the present disclosure, may be integrally provided within an energy absorbing device such as 700a or 700b as shown and illustrated on FIG. 7. As discussed herein, the connecting members and/or (optionally integral) fuses may be formed as uncut sections in the hollow cylindrical body of the energy absorbing device 700a/b. Additionally or alternatively, the integral fuses may be attached to and/or adjoined together with the hollow cylindrical body by suitable means and/or techniques, such as for example, welding, adhesive bonding, brazing, soldering, friction stir welding (FSW), mechanical fasteners (e.g., nuts, bolts, and/or the like), etc. An integral fuse may be utilized for elimination and/or mitigation of an impact, influence, and/or effect of forces of a relatively low magnitude exerted on the energy absorbing device 700a/b and/or an object in which it may be located and/or to be protected thereby. The integral fuse(s) may break and/or the cylindrical helical members may get opened, elongated, and/or deformed substantially inwardly by result, only when the exerted force's magnitude exceeds a predesigned shear force value of the fuse(s).

As shown on FIG. 7, a size of an integral fuse, e.g., cross sectional area thereof, may be defined by a thickness of the cylindrical hollow body, and a length or diameter of the integral fuse in between two notches defining opposite boundaries thereof, such as the length denoted as “A”. The shear force value associated with the fuse may be a function of its size, i.e., cross sectional area of the fuse. Optionally, the shear force value may also depend on properties of the material(s) from which the fuses and/or cylindrical hollow body, as well as any attachment means utilized where applicable, may be made. Table 2 herein shows the resultant shear force for combinations various sizes of the wall thickness S and length A for the connecting member and/or integral fuse(s) such as 70, 71, 72, 73, 74, 75, and/or 76 as shown and illustrated on FIG. 7.

TABLE 2

| | | Thickness | |
|---|---|---|---|
| | A | S | Shear force |
| | [mm] | [mm] | [N] |
| 1 | 2.5 | 2.2 | 3163 |
| 2 | 2.8 | 2.2 | 3542 |
| 3 | 3.1 | 2.2 | 3922 |
| 4 | 3.4 | 2.2 | 4301 |
| 5 | 3.7 | 2.2 | 4693 |
| 6 | 4 | 2.2 | 5060 |

In some exemplary embodiments, an energy absorbing device such as 700a shown on FIG. 7 may comprise a plurality of same and/or similar integral fuses 70 having an equal length A each. Accordingly, the shear force value associated with each of the plurality of integral fuses 70 is identical too, and therefore, upon exertion of an axial force exceeding in magnitude that value, the plurality of integral fuses 70 may break one after another almost instantaneously.

By contrast, in some further exemplary embodiments, another energy absorbing device such as 700b shown on FIG. 7 may comprise a plurality of different and distinct integral fuses 71, 72, 73, 74, 75, and 76, having a variable size (e.g., varying length A) associated with each, such that they are distinguished from one another in the respective shear force value upon which exertion thereof breakage of the corresponding one(s) of the integral fuses 71, 72, 73, 74, 75, and/or 76 may occur. Optionally, the respective length A of each of the integral fuses 71 to 76 may be monotonically increasing, i.e., the lengths Aᵢ may be ordered as a series such as the following: A₇₁<A₇₂<A₇₃<A₇₄<A₇₅<A₇₆. In such a case, the shear force value at which breakage of a respective one of the integral fuses 71 to 76 may occur, also increases accordingly from one fuse to another, starting at integral fuse 71 and ending at integral fuse 76.

As is further illustrated and shown on FIG. 7, the integral fuses 70 of the energy absorbing device 700a and/or integral fuses 71 to 76 of the energy absorbing device 700b, may resemble in construction and/or behavior thereof a notched rectangular bar in tension or simple compression, wherein a distance between opposing notches is denoted as “d”, a total width of the notched rectangular bar between opposing edges that include the notches is denoted as “w”, and a radius of the notches is denoted as “r”. A stress concentration factor Kt relates the highest stress σₘₐₓ to a nominal stress σ₀ of the gross cross-section and defined as

$${K}_{t} = \frac{{σ}_{max}}{{σ}_{0}} .$$

The nominal stress may be expressed as a function of a magnitude of a tension/compression force exerted, denoted as “F”, as in the following:

$$F {σ}_{0} = \frac{F}{A} ,$$

where A=dt and t is the thickness. Table 3 herein shows various exemplary measurements for integral fuses in accordance with some embodiments of the disclosed subject matter.

| | Average | Shear Force | Ultimate | | | | | | | |
|---|---|---|---|---|---|---|---|---|---|---|
| Shear | Shear | w/o Stress | Tensile | | | | | | | |
| Force | Force | Concentration | Strength | | | | | Stress Concentration | | |
| [N] | [N] | [N] | [Mpa] | w | r | t | d | r/d | w/d | Kₜ |
| 392 | | 6890 | 530 | 10 | 2 | 2 | 6.5 | 0.31 | 1.54 | 1.79 |
| 432 | | 7420 | 530 | 10 | 2 | 2 | 7 | 0.29 | 1.43 | 1.75 |
| 344 | | 7420 | 530 | 10 | 1 | 2 | 7 | 0.14 | 1.43 | 2.2 |
| 362 | | 6360 | 530 | 10 | 2 | 2 | 6 | 0.33 | 1.67 | 1.79 |
| 309 | | 6360 | 530 | 10 | 1 | 2 | 6 | 0.17 | 1.67 | 2.1 |
| 318 | | 5300 | 530 | 10 | 2 | 2 | 5 | 0.40 | 2.00 | 1.7 |
| 257 | | 5300 | 530 | 10 | 1 | 2 | 5 | 0.20 | 2.00 | 2.1 |
| 458 | | 4770 | 530 | 10 | 2 | 2 | 4.5 | 0.44 | 2.22 | 1.062 |
| 344 | | 3583 | 530 | 10 | 2 | 2 | 3.38 | 0.59 | 2.96 | 1.062 |
| 322 | 339 | 3163 | 575 | 8 | 3 | 2.2 | 2.5 | 1.20 | 3.20 | 1 |
| 355 | | 3486 | 583 | | 3.1 | 2.3 | 2.6 | 1.24 | 3.08 | |
| 361 | 379 | 3542 | 575 | 8 | 3 | 2.2 | 2.8 | 1.07 | 2.86 | 1 |
| 396 | | 3889 | 583 | | 3.1 | 2.3 | 2.9 | 1.11 | 2.76 | |
| 400 | 406 | 3922 | 575 | 8 | 3 | 2.2 | 3.1 | 0.97 | 2.58 | 1 |
| 412 | | 4291 | 583 | | 3.1 | 2.3 | 3.2 | 0.97 | 0.00 | |
| 438 | 444 | 4301 | 575 | 8 | 3 | 2.2 | 3.4 | 0.88 | 2.35 | 1 |
| 450 | | 4693 | 583 | | 3.1 | 2.3 | 3.5 | 0.89 | 0.00 | |
| 477 | 483 | 4681 | 575 | 8 | 3 | 2.2 | 3.7 | 0.81 | 2.16 | 1 |
| 489 | | 5095 | 583 | | 3.1 | 2.3 | 3.8 | 0.82 | 0.00 | |
| 516 | 522 | 5060 | 575 | 8 | 3 | 2.2 | 4 | 0.75 | 2.00 | 1 |
| 528 | | 5498 | 583 | | 3.1 | 2.3 | 4.1 | 0.76 | 1.95 | |

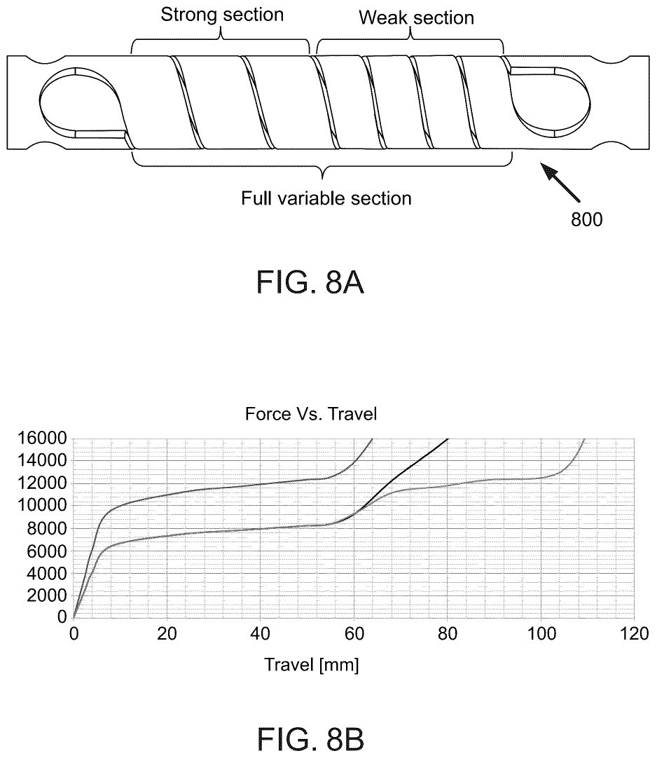

Reference is now made to FIG. 8A that shows a schematic side view of an exemplary energy absorbing device with variable strength sections, in accordance with some embodiments. Reference is also made to FIG. 8B that shows a schematic graph representing an axial force magnitude as a function of an elongation travel of either one of and/or both variable strength sections of the energy absorbing device as shown on FIG. 8A, in accordance with some embodiments.

In some exemplary embodiments, an energy absorbing device such as 800 may comprise a plurality of variable strength sections, for example, a weak section and a strong section serially connected one after another, as shown on FIG. 8A. The variable strength sections may be formed, for example, using different pluralities of cylindrical helical members in the different sections, which may differ in one or more properties, such as pitch, thickness, material composition, and/or the like. As a non-limiting example, in the energy absorbing device 800 the weak section has a pitch (i.e., length of one complete turn or revolution of the helix measured parallel to the main axis thereof) that is lower than the pitch of the strong section. Optionally, the variable strength sections may be formed using different spiral cuts in the cylindrical hollow body to thereby obtain different pluralities of helical cylindrical members with variable pitch, for example. The multiple sections of varying strength attached to one another and/or concatenated together may thus form one single full variable section, as depicted on FIG. 8A.

The energy absorbing device 800 comprising the full variable section and/or weak and strong sections may be utilized for restraining a variety of weights and/or body mass values of different objects and/or persons to be protected from an impact, shockwave, energy blast, and/or the like. For example, in a real-world scenario of having to accommodate for different passengers that may occupy a seat to which the energy absorbing device 800 is adjoined, the weak section, strong section, and/or full variable section may be activated respective of a weight and/or body mass of an occupant passenger at a time. As a non-limiting example, for a first passenger such as a woman in the 5% percentile of weight among the general women population, the weak section only may be activated for an energy absorption event, whereas for a second passenger such as a man in the 95% percentile of weight among the general men population, first the weak and then subsequently the strong section may be activated for performing the energy absorption function in a similar impact.

The schematic graph shown on FIG. 8B depicts three respective functions of a magnitude of force versus an elongation travel of the pluralities of helical cylindrical members in each of the weak, strong, and full variable sections of the energy absorbing device 800 respectively. Within the three depicted functions in the graph, the two which correspond to the weak and strong sections are aimed at showing how the force and travel are correlated when only such single section of a same strength (weak/strong) exists without the other one (i.e., if the energy absorbing device 800 contained only the weak section or only the strong section) whereas the third depicted function is aimed to represent the force-travel correlation for the full variable section in entirety.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean, “is provided in some embodiments and not provided in other embodiments”. Any particular embodiment of the disclosure may include a plurality of “optional” features unless such features conflict.

Throughout this application, various embodiments of this disclosure may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An energy absorbing device comprising:
a plurality of cylindrical base members;
a plurality of metallic helical bands coaxially located around a common longitudinal axis congruent to each other, the plurality of helical bands having a bottom end connected to a bottom base member and a top end connected to a top base; and
a plurality of connecting members located and attached between the plurality of cylindrical helical members along the longitudinal axis.

2. The energy absorbing device of claim 1, wherein the plurality of cylindrical helical members are formed in a single hollow cylindrical body by a plurality of coaxial helical cuts through the single hollow cylindrical body relative to the longitudinal axis.

3. (canceled)

4. The energy absorbing device of claim 1, wherein a plurality of uncut sections in the single hollow cylindrical body relative to the longitudinal axis forms each of the connecting members of the plurality of connecting members.

5. The energy absorbing device of claim 1, wherein pairs of the plurality of connecting members are located laterally opposite each other and aligned with each other along the longitudinal axis.

6. The energy absorbing device of claim 1, wherein application of an axial force across the plurality of cylindrical base members, applies simultaneously a shear force to each connecting member of the plurality of connecting members.

7. The energy absorbing device of claim 6, wherein a predesigned value of the shear force breaks the plurality of connecting members, to open and to elongate and deform substantially inwardly the plurality of cylindrical helical members.

8. The energy absorbing device of claim 6, wherein a first predesigned value of the shear force breaks a first portion of the plurality of connecting members and a second predesigned value of the shear force breaks a second portion of the plurality of connecting members different than the first portion.

9. The energy absorbing device of claim 6, wherein an increasing series of predesigned values of the shear force break different and disjoint portions of the plurality of connecting members at a predefined order thereamong.

10. The energy absorbing device of claim 9, wherein the plurality of connecting members having a variable cross sectional area thereby the increasing series of predesigned values of the shear force break the plurality of connecting members at the predefined order according to respective cross sectional areas thereof.

11. The energy absorbing device of claim 1, wherein the plurality of cylindrical helical members comprising a first and second different and disjoint portions of consecutive cylindrical helical members, each associated with a different one of a first and second set of predesigned values of the shear force as a function of travel of respective consecutive cylindrical helical members therein, the predesigned values in the first and second set respectively are greater than one another per each travel unit.

12. The energy absorbing device of claim 11, wherein the predesigned values in the first and second set are greater than one another by a magnitude substantially proportional to a ratio between a pitch of respective cylindrical helical members in each of the first and second portions.

13. The energy absorbing device of claim 1, wherein the plurality of cylindrical base members are substantially aligned opposite to each other with respect to the longitudinal axis to form at least one of a right hollow cylinder, oblique hollow cylinder and elliptic hollow cylinder.

14. The energy absorbing device of claim 1, wherein the plurality of cylindrical base members are laterally displaced opposite to each other with respect to the longitudinal axis to form at least one of an oblique cylinder, triangular, square, rectangular, hexagonal or any polynomial shape in cross section.

15. An object located and attached in at least one of a vehicle, a vehicular seat, an elevator and a shelf, wherein the object comprises at least one energy absorbing device according to claim 1.
